(19) United States
(12) Patent Application Publication
(10) Pub. No.: US 2009/0178628 A1
(43) Pub. Date: Jul. 16, 2009

(54) METHOD AND APPARATUS FOR PROTECTIVE HEAD GEAR FOR USE ON ANIMALS

(75) Inventors: Tracy Kay Carmean, Payson, AZ (US); Toni Marie Vernetti, Payson, AZ (US)

Correspondence Address: WALLACE, LLC, P.O. BOX 1925, PAYSON, AZ, 85547, US

(73) Assignee: ZONI PETS, LLC, Payson, AZ (US)

(21) Appl. No.: 12/412,618

(22) Filed: Mar. 27, 2009

Related U.S. Application Data
(60) Provisional application No. 61/048,966, filed on Apr. 30, 2008.

(51) Int. Cl. A01K 13/00

(52) U.S. Cl. 119/850

(57) ABSTRACT

An animal headband and a method of use of the animal headband is provided as protective head gear for animals. The protective head gear is configured in such a manner as to provide a substantially uniform compression force against the entire circumference of the head of the animal to securely position the ear flaps of the animal over the ear canal. Dimensions of the protective head gear may be enlarged to facilitate a plurality of placement configurations on the animal. The protective head gear is further useful to secure the ear flaps of the animal away from the ear canal, so as to facilitate medical procedures and subsequent healing from medical procedures involving the ear canal. Securing the ear flaps of the animal away from the ear canal may also promote accelerated drying of the ear canal during conditions that may cause the ear canal to become damp.

This application claims the benefit of U.S. Provisional Application No. 61/048,966, filed Apr. 30, 2008, the contents of which are incorporated herein by reference in their entirety.

### FIELD OF THE INVENTION

The present invention generally relates to protective head gear, and more particularly to protective head gear adapted for use on an animal.

### BACKGROUND

Hearing range usually describes the range of frequencies that can be heard by an animal or human. For humans, the audible range of frequencies is generally 20 Hz to approximately 20,000 Hz. A considerable variation exists from individual to individual, however, especially those individuals whose hearing range declines in direct proportion to their age.

The hearing range of an animal, such as a canine for example, similarly varies with the breed and age of the dog. Nevertheless, the audible range of frequencies for an average canine is generally 20 Hz to approximately 60,000 Hz, which represents an audible frequency range that is approximately three times the audible frequency range of that of an average human.

In addition, a canine's audible frequency reception is enhanced by operation of the canine's ear flap, also called the pinna, which can be upright (i.e., a prick ear) or floppy. The position of a canine's pinna is controlled by at least 18 different muscles, which operate to funnel audible frequency waves into the animal's ear canal. The canine's pinna, therefore, may tilt and rotate in the direction of the source of the audible frequency wave, so as to maximize reception capability.

As a result, sounds that may not be audible to a human are not only audible to a canine, but may be perceived in an extremely amplified fashion by the canine. For example, dog groomers often utilize forced-air drying to facilitate removal of water and other liquid elements from the coat of a dog after the dog has been shampooed and rinsed in preparation for grooming. While a human may perceive the sound that emanates from the forced-air drying nozzle to be loud and irritating, a dog's hearing anatomy amplifies the sound through operation of its pinna to the extent that the sound may become debilitating, or at the very least, extremely agitating to the dog.

Due to the canine's enhanced hearing range, the canine may also perceive harmonics of the fundamental frequencies generated by the forced-air drying nozzle. In such an instance, high-frequency tones and ultrasonic signals that are not audible to a human may nevertheless be audible to the canine. The canine may, therefore, react in a manner that causes the groomer to believe that the canine is physically upset, scared, or otherwise agitated by the drying process when in fact, the canine is simply reacting to audible tones that cannot be perceived by the groomer.

Both the dog and the groomer are, therefore, placed into a contentious relationship during the drying process. As a result, the amount of time required for the drying process is lengthened and the amount of stress imposed upon both the dog and the groomer is increased.

Prior art methods used by animal groomers to attenuate audible frequency waves entering the ear canal of the animal include utilization of cotton balls. In particular, cotton balls are placed into the ear canal of the canine before the drying process begins, so as to attenuate the sound produced by the forced-air drying nozzle during the drying process. While the cotton balls may be effective to attenuate some of the noise entering the dog's ear canal, dogs often find the cotton balls themselves to be quite distracting.

As a result, the dog's tendency is to shake its head rather abruptly in a manner that discharges the cotton ball from the dog's ear canal. Thus, the cotton ball no longer causes a distraction for the dog, but the sound generated by the forced-air drying nozzle continues to distract the dog as discussed above.

Other noise attenuating devices conventionally used to reduce the amplitude of audible frequency waves entering the ear canal of the animal include the use of sound barrier materials. Such devices, however, are designed to promote noise reduction through operation of the sound barrier materials themselves, rather than providing other physical attributes of the device to enhance noise reduction.

Accordingly, the physical attributes of the devices can not be altered to enhance noise reduction performance once the devices have been manufactured. Such prior art devices, therefore, may not be modified to adapt to, e.g., the size of the animal's pinna, the length and height of the animal's cranium, etc., which substantially limits their effectiveness across the various sizes and shapes of animals upon which conventional devices are intended for use.

Efforts continue, therefore, to provide an effective noise attenuation apparatus for animals that remains in place despite the movement of the animal. Furthermore, efforts continue to provide a noise attenuation apparatus whose physical attributes may be adapted in response to the size and shape of the animal, so as to maximize noise attenuation capability of the apparatus.

### SUMMARY

To overcome limitations in the prior art, and to overcome other limitations that will become apparent upon reading and understanding the present specification, various embodiments of the present invention disclose a method and apparatus for use as protective head gear for animals to attenuate audible sound waves entering the ear canal of the animal, which produces a calming effect during excessively noisy events. In addition, the protective head gear is useful to secure the ear flaps of the animal away from the ear canal, so as to facilitate medical procedures and the subsequent healing from such medical procedures involving the ear canal of the animal.

In accordance with one embodiment of the invention, protective head gear for use around the cranial and jaw portions of an animal comprises a cylindrically-shaped head band having first and second ends separated by a length. The cylindrically-shaped head band exhibits a substantially constant circumference along the length to produce a substantially constant surface area within an inner surface of the cylindrically-shaped head band. The cylindrically-shaped head band exhibits a substantially constant modulus of elasticity across the inner surface of the cylindrically-shaped head band. A magnitude of the length is sufficient to completely cover an ear flap of the animal.

In accordance with another embodiment of the invention, a method of utilizing protective head gear for animals comprises selecting a circumference of the protective head gear that is smaller than a circumference of a head of an animal, expanding a first end of the protective head gear to fit around the circumference of the head of the animal, sliding the expanded end of the protective head gear around the head of the animal, and positioning the protective head gear to substantially seal ear canals of the animal using the ear flaps of the animal. A surface area of the protective head gear exerts a substantially constant compression force against the head of the animal once positioned on the animal.

In accordance with another embodiment of the invention, a method of utilizing protective head gear for animals comprises selecting a circumference of the protective head gear that is smaller than a circumference of a head of an animal, expanding a first end of the protective head gear to fit around the circumference of the head of the animal, sliding the expanded end of the protective head gear around the head of the animal, and positioning the protective head gear to substantially separate ear flaps of the animal from ear canals of the animal. A surface area of the protective head gear exerts a substantially constant compression force against the head of the animal once positioned on the animal.

### BRIEF DESCRIPTION OF THE DRAWINGS

Various aspects and advantages of the invention will become apparent upon review of the following detailed description and upon reference to the drawings in which:

FIG. 1A illustrates a cylindrically shaped protective head band for an animal in accordance with one embodiment of the present invention;

FIG. 1B illustrates a polygon shaped portion of material utilized to implement the protective head band of FIG. 1A in accordance with one embodiment of the present invention;

FIG. 2 illustrates an application of the protective head band of FIG. 1A in accordance with one embodiment of the present invention;

FIG. 3 illustrates secure placement of the ear flaps over the ear canal of an animal while wearing the protective head band of FIG. 1A in accordance with one embodiment of the present invention;

FIGS. 4A-4B illustrate secure placement of the ear flaps away from the ear canal of an animal while wearing the protective head band of FIG. 1A in accordance with alternate embodiments of the present invention; and

FIG. 5 illustrates a method of utilizing the protective head gear on animals in accordance with the various embodiments of the present invention.

### DETAILED DESCRIPTION

Generally, the various embodiments of the present invention are applied to animal headbands and a method for use of the headbands as protective head gear for animals. The protective head gear is configured in such a manner as to provide a substantially uniform compression force against the entire circumference of the head of the animal, no matter what size and shape head is exhibited by the animal. As a result, the protective head gear may be utilized to configure the ear flaps, i.e., pinna, of the animal such that the animal's ear canal is either completely covered or completely exposed by the pinna.

In one embodiment, for example, the protective head gear may be utilized to firmly press the animal's pinna up against the cranium in such a fashion that the pinna forms a protective seal over the ear canal. Since the protective head gear is configured to provide a substantially uniform compression force against the head of the animal across the entire surface area of the protective head gear, the comfort level of the animal is enhanced. As a result, calming effects are produced by the protective head band even during noisy or otherwise agitating conditions.

For example, the protective head gear may be used as a noise attenuation device that operates in conjunction with the animal's pinna to attenuate audible frequency waves entering the ear canal of the animal. Such audible frequency waves may be a direct result of excessively noisy events, such as forced-air drying, firework displays, thunderstorms, gun fire, etc. The substantially uniform compression force exerted by the protective head gear effectively conforms to the external profile and physical attributes of the animal's cranium, upper-jaw, lower-jaw, and ear flap so as to maximize comfort and efficiency.

In addition, the magnitude of the substantially uniform compression force exerted by the head gear is sufficient to maintain the head gear in a substantially fixed position on the animal. As a result, once the head gear is affixed to the intended position on the animal, the position of the head gear remains substantially static even during periods of abrupt movement of the animal's head.

Furthermore, the physical attributes of the protective head gear may be adapted to provide enhanced capabilities. As discussed in more detail below, dimensions of the protective head gear may be enlarged to facilitate a plurality of placement configurations on the animal. The actual contact area exhibited by the protective head gear on the head of the animal may be reduced, for example, while the amount of noise attenuation capability is increased.

In an alternate embodiment, the protective head gear is useful to secure the pinna of the animal away from the ear canal, so as to facilitate medical procedures and subsequent healing from medical procedures involving the ear canal. For example, dogs with long floppy ear flaps tend to exhibit an excessive number of occurrences of ear infections due to the inability to keep the ear canal dry. The protective head gear may, therefore, be utilized to secure the animal's ear flap away from the ear canal during medical examinations and treatments that may involve the ear canal of the animal.

In alternate embodiments, the protective head gear may be similarly utilized to secure the animal's ear flap away from the ear canal, so as to increase air flow into the ear canal, thereby increasing the animal's ability to keep the ear canal dry. For example, the pinna of various breeds of animals may prevent adequate drying of the inner ear, especially for breeds that are utilized for water sports, e.g., Labrador retrievers utilized for retrieving downed fowl from bodies of water. As a result, the protective head gear may be utilized to secure the animal's ear flap away from the ear canal, so as to promote accelerated drying of the ear canal during events that may cause the ear canal to become damp.

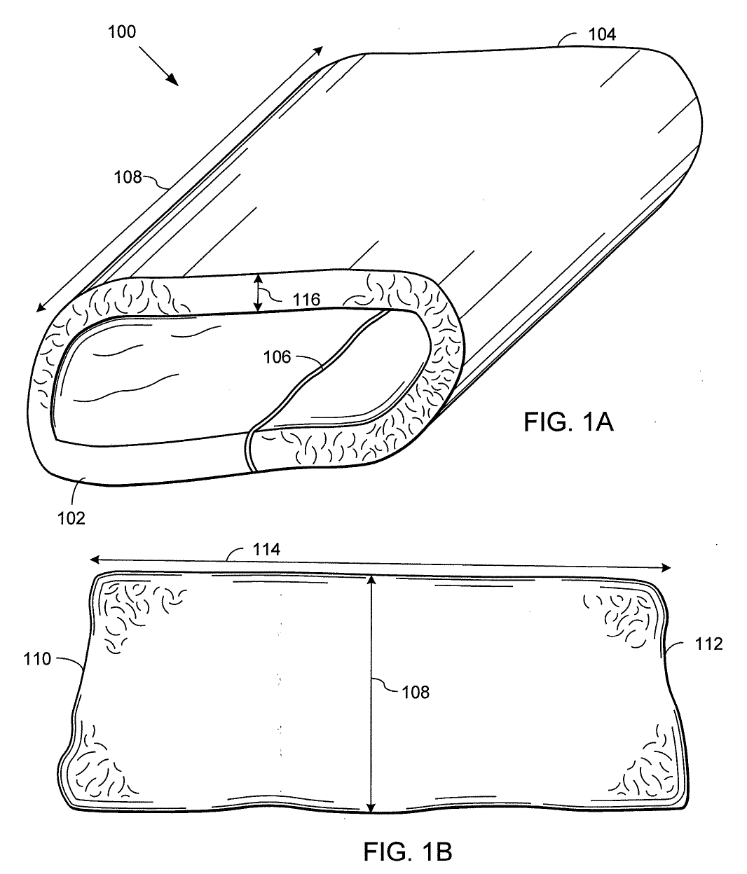

Turning to FIG. 1A, protective head gear that is cylindrically shaped in the form exemplified by band 100 is illustrated in accordance with one embodiment of the present invention. Band 100 may be implemented using a material that comprises a fabric blend of one or more of the following elements: cotton, spandex, polyester, nylon, rayon, elastic, and linen to name only a few.

As discussed in more detail below, the resulting fabric blend should exhibit a substantially constant modulus of elasticity so as to exert substantially constant compression forces across the entire surface area of band 100. The material should also exhibit “breathing” capability, so as to facilitate the passage of air through the material. In addition, the material should withstand wash and sanitization cycles, so that band 100 may be cleaned and reused after each use.

A portion of single-layer material having a polygon shape, such as the substantially quadrilateral shape as exemplified in FIG. 1B, may define first end 110 and second end 112 that when sewn together form band 100 having third end 102 and fourth end 104. Seam 106 is formed by the connection of first end 110 with second end 112. In alternate embodiments, band 100 may instead be formed as a seamless band, whereby a circular loom may be utilized to form band 100. As a result, first end 110 need not be connected to second end 112, which obviates the need to form seam 106 as illustrated in FIG. 1A.

Band 100 may also exhibit multiple layers of material depending upon the particular application. That is to say, in other words, that thickness 116 may be increased/decreased as necessary by adding/subtracting the number of layers of material that are utilized to form thickness 116. As a result, the protection and comfort level that is exhibited by band 100 may be appropriately adjusted in direct proportion to thickness 116.

In any event, band 100 exhibits a substantially cylindrical shape having a fixed circumference when the material of the band is not under stress. That is to say, in other words, that when no expansion forces are applied to the inner portions of the cylinder formed by band 100, the band exhibits an “at-rest” circumference.

When the material of the band is under stress, on the other hand, then the cylindrically shaped band may exhibit a variable circumference depending upon the magnitude of stress exerted on the inner portions of the cylinder formed by band 100. For example, a force exerted on the inner portion of band 100 causes the circumference of band 100 to increase, i.e., the force exerted on band 100 causes band 100 to expand. As the circumference of the band increases, the magnitude of compression force that opposes the expansion of band 100 also increases. The elasticity of the material used to form band 100 is such that the maximum circumference exhibited by band 100 may be, e.g., 2-3 times the at-rest circumference.

Due to the substantially constant modulus of elasticity across the entire surface area of band 100, however, the magnitude of the compression force exerted remains substantially uniform across the surface area of band 100, which as discussed in more detail below, contributes to the comfort of the animal wearing band 100.

As can be seen, therefore, the at-rest circumference of band 100 may be configured in direct proportion to the size of the animal that is to wear band 100. Accordingly, larger animals may require band 100 that exhibits an increased at-rest circumference as compared to the at-rest circumference exhibited by band 100 that is intended for use on smaller animals. In either case, the at-rest circumference of band 100 may be chosen to adequately select the amount of compression force desired.

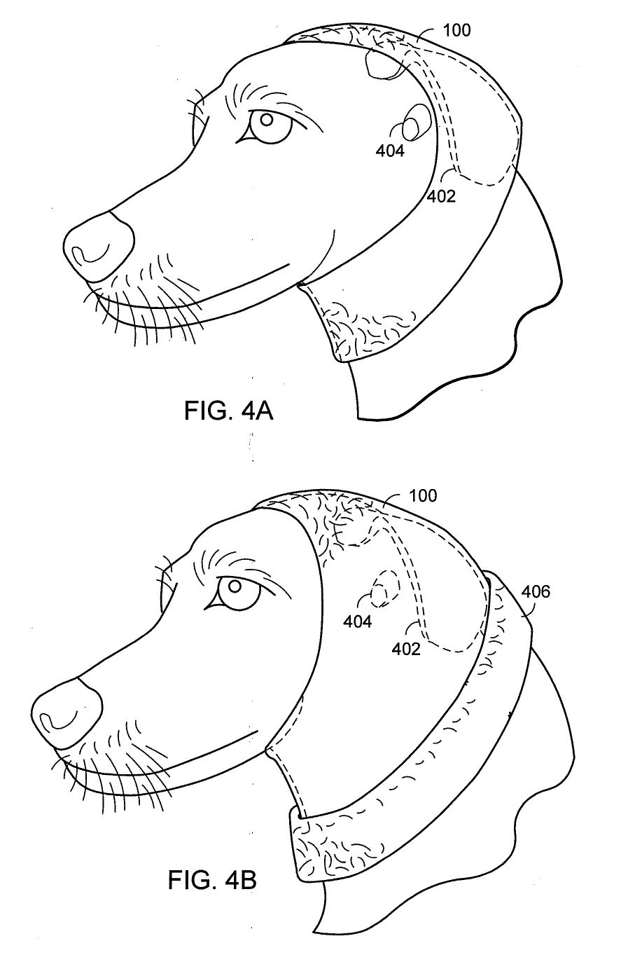

As discussed in more detail below in relation to FIG. 4B, length 108 of band 100 may be increased so as to provide adaptability of the physical attributes of band 100. In particular, length 108 of band 100 may exhibit sufficient magnitude so as to allow a portion of band 100 to be folded over upon itself, thereby decreasing the effective length of band 100 by an amount that is equal to the length of material that is folded over. As a result, the amount of protective covering that is in contact with the animal may be decreased, while the magnitude of protection for the animal is nevertheless increased.

The various types of protection that may be provided by band 100 may assume many different forms. For example, band 100 may combine with the pinna of the animal to substantially seal the opening to the ear canal of the animal. As a result, noise and other agitants may be substantially prevented from entering the ear canal, thereby allowing the animal to remain calm even during events that would otherwise cause the animal to become agitated or disturbed, such as during a forced-air drying event at a pet groomer's facility.

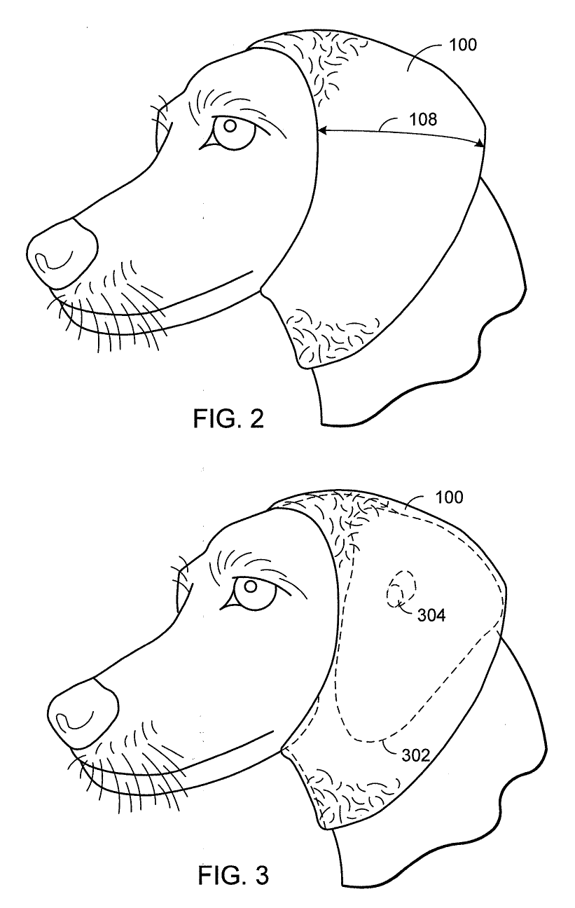

Turning to FIG. 2, one embodiment of an application of the protective head gear is illustrated in accordance with the present invention. It is noted, however, that while the application of FIG. 2 exemplifies use of the protective head gear around the cranium, ear flaps, and the upper/lower jaw of a dog, other applications are provided as well, such as use of the protective head gear on cats and other domesticated animals, such as pot-bellied pigs, horses, Alpacas, Llamas, etc.

As illustrated in FIG. 2, the at-rest circumference of band 100 is sized such that an expansion force exerted on the inner surface of band 100 is required to enlarge one of the openings at end 102 or 104 such that the muzzle and head of the dog may fit within the enlarged opening. Once the protective head gear is correctly positioned, the expansion forces used to enlarge the opening may be released, thereby causing the protective head gear to “cling” to the head area of the dog via compression forces that are exerted by band 100.

In particular, the compression forces exerted by band 100 are substantially uniform across the entire surface area of band 100 that is in contact with the dog. Such a condition is created in part because the entire circumference of band 100 remains substantially constant throughout length 108 of band 100. That is to say, in other words, that dimension 114 remains substantially constant across the entire length 108 of band 100 as illustrated, for example, in FIG. 1B. It is noted that by increasing dimension 114, the circumference of band 100 is increased in direct proportion as well.

The substantially constant modulus of elasticity of the material used to implement band 100 also contributes to the exertion of substantially uniform compression forces. That is to say, in other words, that the ratio of unit stress to unit strain across a uniform cross section of the material used to implement band 100 is substantially constant. As a result, the magnitude of compression force exerted by each unit square area of band 100 is substantially constant, which promotes a particularly comfortable experience for the dog while band 100 is applied to the dog.

Turning to FIG. 3, the correct placement of the dog's pinna is illustrated in accordance with one embodiment of the present invention. In particular, band 100 is applied to completely protect ear flap 302, where it is understood that the opposing ear flap (not shown) is similarly protected by band 100. Since the compression forces exerted by band 100 are substantially constant, a substantially equal amount of force is utilized to comfortably press each ear flap 302 against the animal. As a result, ear flaps 302 are held against respective ear canals 304 so as to attenuate the magnitude of noise and other agitants that may enter ear canal 304.

Turning to FIG. 4A, the correct placement of the dog's pinna is exemplified in accordance with an alternate embodiment of the present invention. In particular, band 100 is applied to secure ear flaps 402 away from respective ear canals 404. Since the compression forces exerted by band 100 are substantially constant, a substantially equal amount of force is utilized to comfortably secure each ear flap 402 away from ear canal 404 as illustrated.

As a result, ear flaps 402 are secured away from respective ear canals 404 so as to facilitate medical procedures and the subsequent healing from such medical procedures involving ear canals 404. For example, dogs with long floppy ear flaps tend to exhibit an excessive number of occurrences of ear infections due to the inability to adequately dry the ear canal. Band 100 may, therefore, be utilized to secure ear flaps 402 away from respective ear canals 404 during medical examinations and treatments that may involve the ear canal.

In alternate embodiments, as exemplified in FIG. 4B, band 100 may be similarly utilized to secure ear flaps 402 away from respective ear canals 404, so as to increase air flow into each of ear canal 404, thereby increasing the animal's ability to keep ear canals 404 dry. For example, the pinna of various breeds of animals may prevent adequate drying of the inner ear, especially for breeds that are utilized for water sports, e.g., Labrador retrievers utilized for retrieving downed fowl from bodies of water. As a result, band 100 may be utilized to secure ear flaps 402 away from respective ear canals 404, so as to promote accelerated drying of ear canals 404 during events that may cause ear canals 404 to become wet.

As illustrated in FIG. 4B, band 100 may secure ear flaps 402 away from respective ear canals 404, while at the same time providing a protective covering over ear canal 404. Since the material used to implement band 100 may be allowed to “breathe”, accelerated drying is facilitated because air is allowed to pass through band 100 into ear canal 404 so as to aerate ear canal 404.

An additional feature of band 100 is illustrated in FIG. 4B, such that length 108 of band 100 may be increased so as to provide adaptability of the physical attributes of band 100. In particular, length 108 of band 100 may exhibit sufficient magnitude so as to allow a portion of band 100, e.g., portion 406, to be folded over upon itself while maintaining adequate coverage over the animal's head.

As a result, the amount of protective covering that is in contact with the animal's head may be decreased, while the magnitude of protection for the animal is nevertheless increased due to the double-layer of protective covering established by the fold. It is noted that while the length of portion 406, as illustrated in FIG. 4B, is relatively short, the length of portion 406 may be increased up to the point that band 100 is halved in length. As a result, portion 406 completely overlaps band 100 to provide a double layer of protection around the head of the animal. It is further noted that folded portion 406 may also be implemented for the applications illustrated in FIGS. 2-3 and 4A as well.

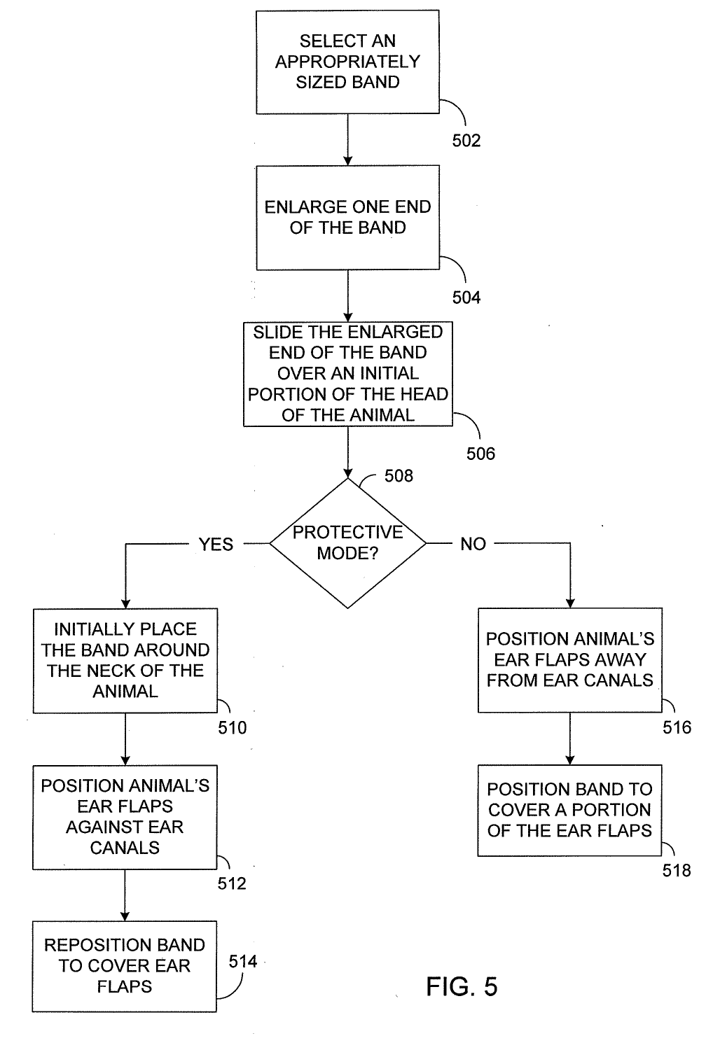

Turning to FIG. 5, a method of utilizing the protective head gear in accordance with the various embodiments of the present invention is illustrated. In step 502, appropriately sized protective head gear is selected in accordance with the size of the animal that is to wear the protective head gear. In particular, the at-rest circumference of the protective head gear should be sized such that an expansion force exerted on the inner surface of the protective head gear is required to enlarge one of the openings of the protective head gear such that a portion of the animal's head may fit within the opening(s) enlarged as in steps 504 and 506.

In step 508, it is determined in which mode the protective head gear is to be utilized. If the protective head gear is to be utilized to attenuate the magnitude of noise and other agitants that may enter the ear canal of the animal, then steps 510-514 are executed. If, on the other hand, the ear flaps are to be secured away from the respective ear canals of the animal, then steps 516-518 are to be executed.

In step 510, a protective mode of operation is initiated, whereby the protective head gear is initially placed over the neck portion of the animal. Next, as in step 512, the animal's ear flaps are positioned such that each ear canal is completely covered by each respective ear flap.

The protective head gear is then repositioned in step 514 as exemplified in FIG. 3, such that the protective head gear completely covers the ear flap as illustrated. In alternate embodiments, length 108 of the protective head gear may be extended as illustrated in FIG. 4B, such that portion 406 of the protective head gear may be folded over on itself in step 514, thereby decreasing the effective length of the protective head gear by an amount that is equal to the amount folded over.

As a result, the amount of protective covering that is in contact with the animal may be decreased, while the magnitude of protection for the animal is nevertheless increased. For example, the amount of compression force exerted by the protective covering may be increased by the folded portion.

In step 516, a medical facilitation mode is instead initiated, whereby the protective head gear is positioned to secure ear flaps away from the respective ear canals for medical reasons as illustrated in FIG. 4A. For example, animals with long floppy ear flaps tend to exhibit an excessive number of occurrences of ear infections due to the inability to adequately dry the ear canal. The protective head gear may, therefore, be utilized to secure the ear flaps away from the respective ear canals during medical examinations and cleaning of the ear canal to prevent such ear infections.

Alternately, the protective head gear may be similarly utilized to secure the ear flaps away from the respective ear canals, so as to increase air flow into each of the ear canals, thereby increasing the animal's ability to keep the ear canals dry as illustrated in FIG. 4B. Next, the protective head gear is then positioned over a portion of the ear flaps in step 518 so as to secure the ear flaps in place to facilitate air flow into the ear canals.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. Protective head gear for use around the cranial and jaw portions of an animal, the protective head gear comprising:
a cylindrically-shaped head band having first and second ends separated by a length, the cylindrically-shaped head band exhibiting a substantially constant circumference along the length to produce a substantially constant surface area within an inner surface of the cylindrically-shaped head band;
wherein the cylindrically-shaped head band exhibits a substantially constant modulus of elasticity across the inner surface of the cylindrically-shaped head band; and
wherein a magnitude of the length is sufficient to completely cover an ear flap of the animal.

2. The protective head gear of claim 1, wherein the cylindrically-shaped head band comprises a polygon-shaped material having third and fourth ends coupled together, the third and fourth ends being coupled together to form a seam along the length.

3. The protective head gear of claim 2, wherein the polygon-shaped material comprises one or more of cotton, spandex, polyester, nylon, rayon, elastic, and linen.

4. The protective head gear of claim 1, wherein the cylindrically-shaped head band comprises a seamless material.

5. The protective head gear of claim 4, wherein the seamless material comprises one or more of cotton, spandex, polyester, nylon, rayon, elastic, and linen.

6. A method of utilizing protective head gear for animals, the method comprising:
selecting a circumference of the protective head gear that is smaller than a circumference of a head of an animal;
expanding a first end of the protective head gear to fit around the circumference of the head of the animal;
sliding the expanded end of the protective head gear around the head of the animal;
positioning the protective head gear to substantially seal ear canals of the animal using the ear flaps of the animal; and
wherein a surface area of the protective head gear exerts a substantially constant compression force against the head of the animal.

7. The method of claim 6, wherein selection of the circumference determines a magnitude of the substantially constant compression force.

8. The method of claim 6, wherein expanding a first end of the protective head gear comprises exerting an expansion force against an inner surface of the protective head gear.

9. The method of claim 8, wherein positioning the protective head gear comprises initially sliding the protective head gear around the neck of the animal.

10. The method of claim 9, wherein positioning the protective head gear further comprises positioning the ear flaps over the ear canals of the animal.

11. The method of claim 10, wherein positioning the protective head gear further comprises repositioning the protective head gear to substantially seal ear canals of the animal using the ear flaps of the animal.

12. The method of claim 6, further comprising folding a portion of the protective head gear over on itself to reduce a magnitude of surface area in contact with the head of the animal, wherein the reduced surface area substantially covers the ear flaps of the animal.

13. A method of utilizing protective head gear for animals, the method comprising:
selecting a circumference of the protective head gear that is smaller than a circumference of a head of an animal;
expanding a first end of the protective head gear to fit around the circumference of the head of the animal;
sliding the expanded end of the protective head gear around the head of the animal;
positioning the protective head gear to substantially separate ear flaps of the animal from ear canals of the animal; and
wherein a surface area of the protective head gear exerts a substantially constant compression force against the head of the animal.

14. The method of claim 13, wherein selection of the circumference determines a magnitude of the substantially constant compression force.

15. The method of claim 13, wherein expanding a first end of the protective head gear comprises exerting an expansion force against an inner surface of the protective head gear.

16. The method of claim 13, wherein positioning the protective head gear comprises positioning the ear flaps away from the ear canals of the animal.

17. The method of claim 16, wherein positioning the protective head gear further comprises repositioning the protective head gear to secure the ear flaps away from the ear canals of the animal.

18. The method of claim 17, wherein positioning the protective head gear further comprises positioning the protective head gear away from the ear canals of the animal.

19. The method of claim 17, wherein positioning the protective head gear further comprises positioning the protective head gear over the ear canals of the animal.

20. The method of claim 13, further comprising folding a portion of the protective head gear over on itself to reduce a magnitude of surface area in contact with the head of the animal, wherein the reduced surface area substantially covers the ear flaps of the animal.
